(19) United States
(12) Patent Application Publication
(10) Pub. No.: US 2016/0347200 A1
(43) Pub. Date: Dec. 1, 2016

(54) Fuel Cell Vehicle

(71) Applicant: TOYOTA JIDOSHA KABUSHIKI KAISHA, Toyota-shi (JP)

(72) Inventor: Masaaki MATSUSUE, Mishima-shi (JP)

(73) Assignee: TOYOTA JIDOSHA KABUSHIKI KAISHA, Toyota-shi (JP)

(21) Appl. No.: 15/160,182

(22) Filed: May 20, 2016

(30) Foreign Application Priority Data
May 27, 2015 (JP) 2015-107762

(51) Int. Cl. B60L 11/18; H01M 8/1018; H01M 8/04992; H01M 8/043; H01M 8/04537; H01M 8/04828; H01M 8/1007; H01M 8/1016

(52) U.S. Cl. CPC B60L 11/1881; H01M 8/1007; H01M 8/1018; H01M 8/1016; H01M 8/043; H01M 8/04589; H01M 8/04649; H01M 8/0491; H01M 8/04992; B60L 11/1803; H01M 2008/1095; B60L 2250/26; B60L 2240/429

(57) ABSTRACT

A fuel cell vehicle includes an accelerating state detector, an electric resistance value detector, a current value detector and a controller. The controller is configured to determine a target current value output from the fuel cell stack based on a requested output value of the fuel cell stack in accordance with the detected accelerating state, determine a current increase rate based on a difference between the determined target current value and the detected current value, and correct the determined target current value in such a manner as to reduce the determined target current value in a case where a value of a function that includes the determined target current value, the determined current increase rate, and the detected electric resistance value becomes larger than a predetermined threshold.

### INCORPORATION BY REFERENCE

The disclosure of Japanese Patent Application No. 2015-107762 filed on May 27, 2015 including the specification, drawings and abstract is incorporated herein by reference in its entirety.

### BACKGROUND OF THE INVENTION

### 1. Field of the Invention

The invention relates to a fuel cell vehicle.

### 2. Description of Related Art

Conventionally, a fuel cell generator that detects a rapid increase in external load command value from a change in output current of a fuel cell and keeps a current increase rate of the fuel cell at a predetermined constant value to suppress a reduction in generated voltage that occurs at a time when an external load command is large has been known (for example, see Japanese Patent Application Publication No. 7-57753 (JP 7-57753 A)).

However, the reduction in the generated voltage and a reduction in output of the fuel cell are possibly influenced not only by a magnitude of the external load command but also by a dried state of a cell of a fuel cell and the current increase rate. Accordingly, in the case where the current increase rate is set to be low in advance in the technique disclosed in JP 7-57753 A, responsiveness to a rapid output increase request such as a wide open throttle (WOT) is possibly degraded. On the contrary, in the case where the current increase rate is set to be high in advance, the voltage and the output are possibly reduced depending on the dried state of the cell of the fuel cell.

### SUMMARY OF THE INVENTION

The invention provides a fuel cell vehicle that can suppress a voltage reduction and can promptly obtain target output even in the case where a cell of a fuel cell is in a dried state and a rapid output increase request such as WOT is made.

A first aspect of the invention relates to a fuel cell vehicle that includes: a fuel cell stack that generates electric power when being supplied with oxidant gas and fuel gas; an accelerating state detector that detects an accelerating state of the vehicle; an electric resistance value detector that detects an electric resistance value of the fuel cell stack; a current value detector that detects a current value of the fuel cell stack; and a controller configured to determine a target current value output from the fuel cell stack based on a requested output value of the fuel cell stack in accordance with the detected accelerating state, determine a current increase rate based on a difference between the determined target current value and the detected current value, and correct the determined target current value in such a manner as to reduce the determined target current value in a case where a value of a function that includes the determined target current value, the determined current increase rate, and the detected electric resistance value becomes larger than a predetermined threshold.

In this way, even in the case where a cell of a fuel cell is in a dried state and a rapid output increase request, such as a WOT, is made, the fuel cell vehicle can suppress a reduction in voltage and can promptly obtain target output.

A second aspect of the invention relates to a fuel cell vehicle that includes: a fuel cell stack that generates electric power when being supplied with oxidant gas and fuel gas; an accelerating state detector that detects an accelerating state of the vehicle; an electric resistance value detector that detects an electric resistance value of the fuel cell stack; a current value detector that detects a current value of the fuel cell stack; and a controller configured to determine a target current value output from the fuel cell stack based on a requested output value of the fuel cell stack in accordance with the detected accelerating state, determine a current increase rate based on a difference between the target current value and the detected current value, and correct the determined target current value in such a manner as to reduce the determined target current value in a case where at least one value among the determined target current value, the determined current increase rate, and the detected electric resistance value becomes larger than a threshold set for the at least one value.

Even in the case where the cell of the fuel cell is in the dried state and the rapid output increase request, such as the WOT, is made, such a fuel cell vehicle can also suppress the reduction in the voltage and can promptly obtain the target output.

According to the fuel cell vehicle disclosed in this specification, even in the case where the cell of the fuel cell is in the dried state and the rapid output increase request, such as the WOT, is made, the reduction in the voltage can be suppressed, and the target output can be supplied.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an explanatory view that shows a schematic configuration of a fuel cell vehicle of a first embodiment;

FIG. 2 is a graph that shows one example of each of an I-V curve and an I-P curve of a fuel cell stack in the first embodiment;

FIG. 3 is an explanatory chart that schematically shows current distribution in the cell included in the fuel cell stack;

FIG. 4 is an explanatory chart that shows a difference in the I-V curve caused by a difference in position in the cell of the fuel cell;

FIG. 5A is a graph that shows temporal changes in current and voltage in the fuel cell of the first embodiment;

FIG. 5B is a graph that shows a temporal change in output;

FIG. 6 is a flowchart that shows one example of control of the fuel cell vehicle of the first embodiment;

FIG. 7 is a graph that shows a temporal change in the output in the case where target current value correction control is executed;

FIG. 8 is a graph that shows a change in cell voltage in the case where a current increase rate is high;

FIG. 9 is a graph that shows a change in the cell voltage in the case where the current increase rate is low; and

FIG. 10 is a flowchart that shows one example of control of a fuel cell vehicle of a second embodiment.

### DETAILED DESCRIPTION OF EMBODIMENTS

A description will hereinafter be made on embodiments of the invention with reference to the accompanied drawings. Noted that each section in the drawings is possibly shown in such a manner that dimension, a ratio, and the like thereof do not completely correspond to the actual dimension, ratio, and the like thereof.

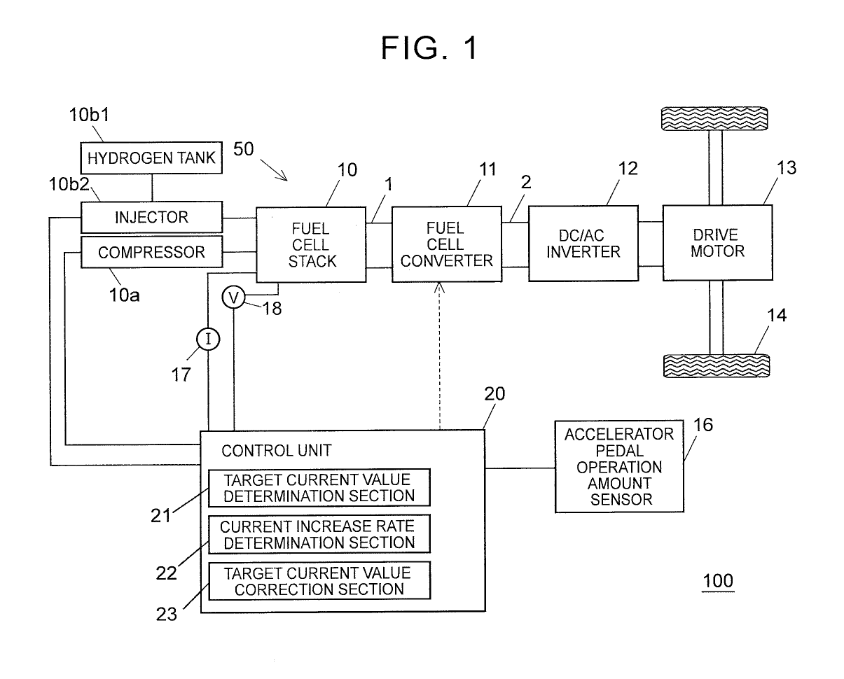

(First Embodiment) First, a description will be made on a fuel cell vehicle 100 of a first embodiment with reference to FIG. 1. The fuel cell vehicle 100 includes a fuel cell system 50. The fuel cell system 50 includes a fuel cell stack 10, a fuel cell converter 11, a DC/AC inverter 12, and a drive motor 13. Drive wheels 14 are mechanically connected to the drive motor 13. The fuel cell vehicle 100 also includes a control unit 20 that corresponds to a control means. The control unit 20 generates drive power of the fuel cell vehicle 100 in correspondence with a request of a driver. An accelerator pedal operation amount sensor 16 is electrically connected to the control unit 20. The accelerator pedal operation amount sensor 16 functions as an accelerating state detection means for detecting an accelerating state of the vehicle.

Noted that, in addition to installation in the fuel cell vehicle 100 for use, the fuel cell system 50 can be installed in various types of moving bodies such as a watercraft, an aircraft, and a robot.

The fuel cell stack 10 is a solid polymer type fuel cell in which plural cells are stacked. The fuel cell stack 10 generates electric power when being supplied with air as oxidant gas and hydrogen as fuel gas. The fuel cell stack 10 is not limited to the fuel cell of solid polymer type, but any of various types of fuel batteries can be adopted therefore. For example, instead of the solid polymer type fuel cell, a solid oxide type fuel cell may be adopted as the fuel cell stack 10.

A compressor 10a for supplying the air into the fuel cell stack 10 is connected to the fuel cell stack 10. A hydrogen tank 10b1 is also connected to the fuel cell stack 10. An injector 10b2 is arranged in a pipe for connecting between the fuel cell stack 10 and the hydrogen tank 10b1. The compressor 10a and the injector 10b2 are each electrically connected to the control unit 20.

An ammeter 17 that functions as current value detection means for detecting a current value of the fuel cell stack 10 is connected to the fuel cell stack 10. A voltmeter 18 for detecting a voltage value of the fuel cell stack 10 is also connected to the fuel cell stack 10. The ammeter 17 and the voltmeter 18 each function as a part of electric resistance detection means for detecting an electric resistance value of the fuel cell stack 10.

The fuel cell stack 10 is connected to an input terminal of the fuel cell converter 11 via a first DC lead wire 1. The fuel cell converter 11 is a booster converter that boosts and outputs a voltage input from the fuel cell stack 10 to a target voltage in response to a command from the control unit 20. An output terminal of the fuel cell converter 11 is connected to a DC terminal of the DC/AC inverter 12 via a second DC lead wire 2.

The drive motor 13 is a drive power source for driving the drive wheels 14 of the fuel cell vehicle 100, and is constructed of a three-phase AC motor, for example. The drive motor 13 is connected to an AC terminal of the DC/AC inverter 12 via an AC lead wire. The DC/AC inverter 12 converts DC power that is supplied from the fuel cell stack 10 via the second DC lead wire 2 into three-phase AC power and supplies the three-phase AC power to the drive motor 13 in response to a command from the control unit 20. In addition, the DC/AC inverter 12 converts regenerative power generated in the drive motor 13 into the DC power and outputs the DC power to the second DC lead wire 2.

The control unit 20 controls the current value output from the fuel cell stack 10. The control unit 20 is constructed of a microcomputer that includes a central processing unit, a main memory, and a non-volatile memory section. The control unit 20 is formed with a target current value determination section 21, a current increase rate determination section 22, and a target current value correction section 23. The target current value determination section 21 determines a target current value output from the fuel cell stack 10 on the basis of a requested output value of the fuel cell stack 10 that corresponds to the accelerating state detected, for example, by the accelerator pedal operation amount sensor 16 that functions as the accelerating state detection means. The current increase rate determination section 22 determines a current increase rate on the basis of a difference between the target current value determined by the target current value determination section 21 and the current value detected by the ammeter 17 that corresponds to the current value detection means. In addition, the target current value correction section 23 corrects the target current value determined by the target current value determination section 21. Various types of processing that are executed in the target current value determination section 21, the current increase rate determination section 22, and the target current value correction section 23 will be described below in detail.

The control unit 20 controls output of the fuel cell stack 10 by controlling the fuel cell converter 11 and the DC/AC inverter 12 and makes the drive motor 13 generate the drive power that corresponds to an output request (requested system output) from the outside. The control unit 20 is connected to the fuel cell converter 11 and the DC/AC inverter 12 via a signal wire. The control unit 20 generates a control signal corresponding to the output request from the outside, for example, a requested value by the accelerator pedal operation amount sensor 16 and controls an operation of the fuel cell converter 11.

The control unit 20 executes output setting processing for the fuel cell stack 10 on the basis of the value that is obtained from the accelerator pedal operation amount sensor 16, That is, the control unit 20 sets a current value to be output from the fuel cell stack 10 from an air supply amount, a hydrogen supply amount, hydrogen pressure, output history, the voltage, a current value map, and the like.

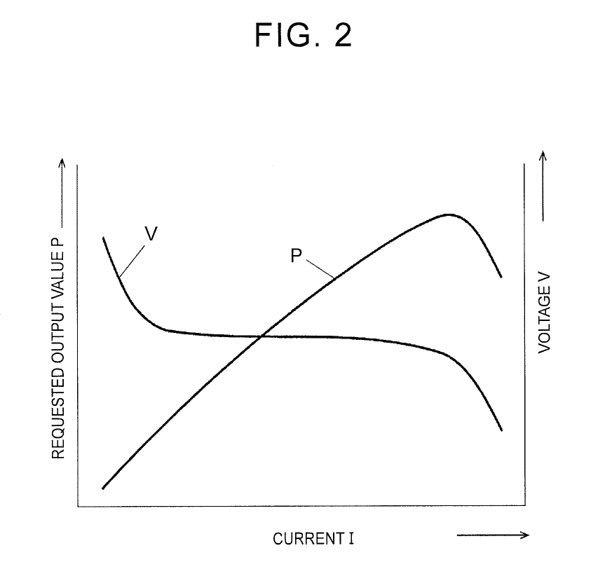

The target current value determination section 21 included in the control unit 20 detects that an accelerator pedal is depressed on the basis of the value obtained from the accelerator pedal operation amount sensor 16, and comprehends a requested output value P that is requested for the fuel cell stack 10 on the basis of the value. Then, with reference to FIG. 2, the target current value determination section 21 obtains a target current value Itrg from a relationship between the requested output value P and a current I. Once the target current value Itrg is determined, a voltage value that corresponds to the target current value Itrg can be obtained from a current/voltage property, that is, an IV curve. The fuel cell system 50 boosts this voltage by the DC/AC inverter 12 and thereby outputs a voltage corresponding to the requested system output that is requested for the drive motor 13.

Based on the target current value Itrg, the control unit 20 obtains a requested oxygen flow amount and a requested hydrogen flow amount supplied to the fuel cell stack 10. The requested oxygen flow amount and the requested hydrogen flow amount are each determined on the basis of a map that is set on the basis of an operation model of the fuel cell stack 10, The control unit 20 operates the compressor 10a so as to realize the requested oxygen flow amount that has been determined. The control unit 20 also operates the injector 10b2 so as to realize the requested hydrogen flow amount that has been determined.

The control unit 20 obtains a resistance value R of the fuel cell stack 10 through measurement of an impedance. More specifically, the control unit 20 causes periodical fluctuations in the voltage or the current, and obtains the resistance value R of the fuel cell stack 10 at the time on the basis of the current value detected by the ammeter 17 and the voltage value detected by the voltmeter 18 at the time. Just as described, together with the ammeter 17 and the voltmeter 18, the control unit 20 functions as an electric resistance value detection means.

The current increase rate determination section 22 included in the control unit 20 obtains a current increase rate S that is determined in advance as a rate of the current value to reach the target current value Itrg. More specifically, the current increase rate determination section 22 determines the current increase rate S by dividing a difference between the target current value Itrg determined by the target current value determination section 21 and the current value detected by the ammeter 17 by a time period T as an interval between measurement of these values.

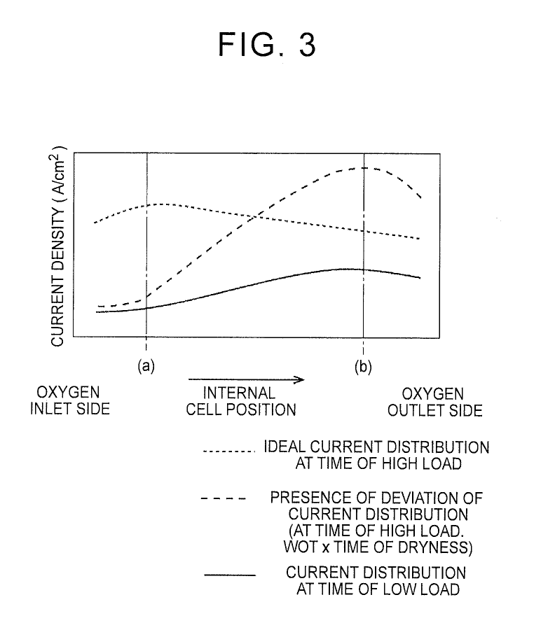

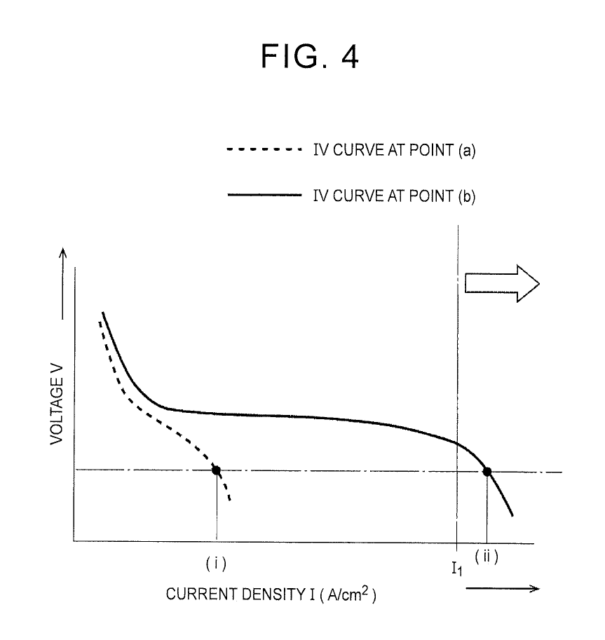

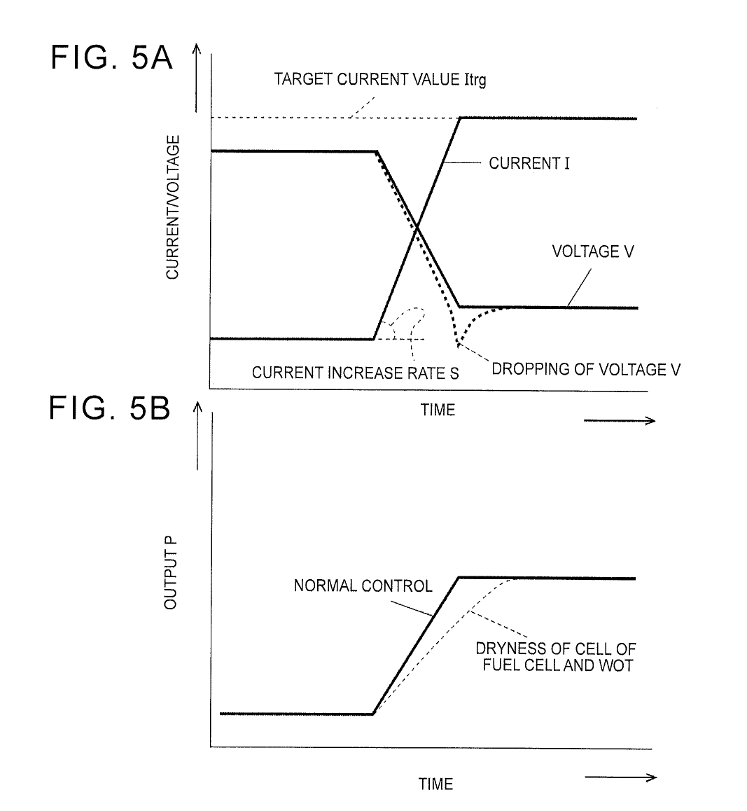

Here, a description will be made on a phenomenon that is envisioned in the case where the current value of the fuel cell stack 10 is attempted to reach the target current value Itrg at the current increase rate S computed as described above with reference to FIG. 3, FIG. 4, FIG. 5A, and FIG. 5B.

FIG. 3 is an explanatory chart that schematically shows current distribution in the cell included in the fuel cell stack. With reference to FIG. 3, it is understood that differences in the current distribution are observed in one cell of a fuel cell. At times of a low load, as indicated by a solid line in FIG. 3, the distribution in which a difference in current density (A/cm²) is small in an entire range from an oxygen inlet side to an oxygen outlet side is observed. The ideal current distribution at time of a high load is, as indicated by a dotted line in FIG. 3, in a state where the difference in the current density (A/cm²) is small in the entire region from the oxygen inlet side to the oxygen outlet side. On the contrary, as indicated by a broken line in FIG. 3, there is a case where the current distribution in which the current density (A/cm²) on the oxygen inlet side is low and the current density (A/cm²) is increased toward the oxygen outlet side is observed. More specifically, the current density (A/cm²) at a point (a) is low when compared to the ideal current distribution, and the current density (A/cm²) at a point (b) is high when compared to the ideal current distribution. Such deviation of the current distribution in the cell of the fuel cell is observed in the case where the cell of the fuel cell is in a dried state and a rapid output increase such as the WOT is requested.

That is, when the rapid output increase request is made, the air flow amount that flows into the fuel cell stack 10 is increased. Here, dried air is usually supplied to the fuel cell stack 10. Accordingly, when the air flow amount is increased, dryness on the oxygen inlet side of the cell included in the fuel cell stack 10 is further progressed. With progression of the dryness on the oxygen inlet side, as indicated by the broken line in FIG. 3, the current density on the oxygen inlet side is reduced. Accordingly, a power generation amount that corresponds to this reduction in the current density on the oxygen inlet side has to be compensated on the oxygen outlet side. As a result, the current density on the oxygen outlet side is increased in the cell of the fuel cell.

More specifically, an IV curve indicated by a broken line in FIG. 4 is measured at a point (a) near the oxygen inlet in a state where the deviation of the current distribution in the cell of the fuel cell, which is indicated by the broken line in FIG. 3, is observed. Meanwhile, an IV curve indicated by a solid line is measured at a point (b) near the oxygen outlet in the state where the deviation of the current distribution in the cell of the fuel cell, which is indicated by the broken line in FIG. 3, is observed. Just as described, the IV curves in the state where the deviation of the current distribution is observed are illustrated as different curves depending on a distance from the oxygen inlet in the cell of the fuel cell. A gradient of the IV curve indicated by the broken line is steep when compared to the IV curve indicated by the solid line. This is due to a fact that the oxygen inlet side of the cell of the fuel cell is in the dried state. When the gradient of the IV curve is steep, a reduced amount of the voltage is increased even in the low current density region. In addition, the current density itself is in a state of not being able to reach a high value. It is assumed that the current density on the oxygen inlet side becomes a value indicated by (i) in such a state. This value is a value that is separated from the current density at the point (a) in the ideal current distribution at the time of the high load as shown in FIG. 3. For this reason, the current density on the oxygen outlet side in the one cell of the fuel cell is increased in order to obtain the power generation amount requested for the cell of the fuel cell. More specifically, the current density at the point (b) in FIG. 3, under the conditions where the cell of the fuel cell is in the dried state and the WOT is requested, is higher than the current density at the point (b) in the ideal current distribution at the time of the high load.

A voltage value of the one cell of the fuel cell serves as one value. Accordingly, in the case where the current density on the oxygen inlet side becomes the value indicated by (i) in FIG. 4, the voltage value of the cell of the fuel cell becomes a value that corresponds to the current value indicated by (i). Thus, the voltage value at the point (b) also becomes a value that corresponds to the current value indicated by (i). When being applied to the IV curve at the point (b), which is indicated by the solid line in FIG. 4, this value becomes the value (ii). Here, attention is focused on the IV curve at the point (b). In the IV curve at the point (b), a region where the current density is higher than I₁ (A/cm²) is a region where the voltage is rapidly reduced. In such a region where the voltage is rapidly reduced, a rate at which the voltage value is reduced is higher than a rate at which the current density is increased. As a result, the output P of the fuel cell stack 10 is reduced.

Just as described, in the case where the cell of the fuel cell is in the dried state and the rapid output increase request such as the WOT is made, the current distribution is deviated in the cell of the fuel cell, and then the voltage of the fuel cell stack 10 drops as indicated by a dotted line in FIG. 5A and an output P decreases as indicated by a dotted line in FIG. 5B. Noted that normal control in FIGS. 5A, 5B each show a temporal change in the output in the case where the cell of the fuel cell is in the dried state and the rapid output increase request such as the WOT is not made.

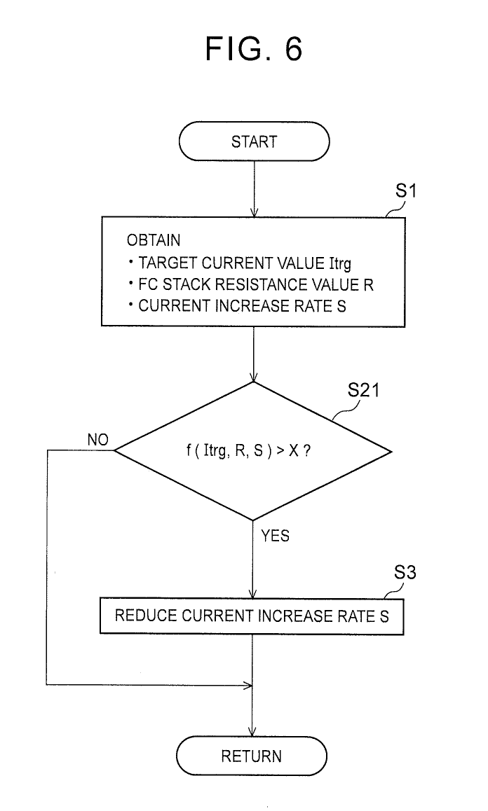

Accordingly, in the fuel cell vehicle 100 of this embodiment, control for avoiding such a reduction in the output P is executed. A description will hereinafter be made on one example of the control with reference to a flowchart in FIG. 6.

In step S1, the target current value Itrg, the fuel cell stack resistance value R, and the current increase rate S are obtained. These values are periodically obtained at every time the time period T elapses. Of these values, in order to obtain the target current value Itrg, the requested system output that is requested for the fuel cell system 50 is first obtained from a magnitude of depression of an accelerator pedal detected by the accelerator pedal operation amount sensor 16. The requested system output is obtained by referring to the map that is created based on the operation model correlated with an accelerator operation amount in advance. Then, requested output of the fuel cell stack 10 is determined based on the obtained requested system output. For example, in the case where a battery is incorporated in the fuel cell system 50, in consideration of a remaining capacity of the battery, a distribution ratio of requested output of the battery and the requested output of the fuel cell stack 10 is determined. Then, the requested output of the fuel cell stack 10 is determined based on this distribution ratio. After the requested output of the fuel cell stack 10 is determined, the target current value Itrg is determined from the relationship between the current I and the output P shown in FIG. 2, for example.

The fuel cell stack resistance value R is obtained based on the current value detected by the ammeter 17 and the voltage value detected by the voltmeter 18 at the time when the voltage or the current is periodically fluctuated.

The current increase rate S is obtained by dividing the difference between the target current value Itrg determined by the target current value determination section 21 and the current value detected by the ammeter 17 by the time period T as the interval between measurement of these values. That is, the current increase rate S indicates how much the current value is increased within the time period T.

After the target current value Itrg, the fuel cell stack resistance value R, and the current increase rate S are obtained in step S1, it is determined in step S2 whether a function f(Itrg, R, 5) containing these values is larger than a threshold X. Here, the threshold X will be described. The target current value Itrg, the fuel cell stack resistance value R, and the current increase rate S that are obtained in step S1 can be used as parameters to evaluate the deviation of the current distribution in the cell of the fuel cell, in turn, as parameters to evaluate the voltage reduced amount.

As described above, the deviation of the current distribution in the cell of the fuel cell is correlated with a degree of dryness of the cell of the fuel cell, that is, moisture distribution. In addition, the deviation of the current distribution causes a reduction in the voltage. As the deviation of the current distribution is increased, and as the current density on the oxygen outlet side is increased, the voltage reduced amount is also increased. Accordingly, in this embodiment, based on these findings, Itrg, R, S are changed, and the current distribution is measured in advance to determine a relationship between the voltage and f(Itrg, R, S). That is, a combination of Itrg, R, S is changed variously, and the current distribution is measured in an experiment so as to determine the relationship between the voltage and f(Itrg, R, S). In this way, a relationship between the moisture distribution in the cell of the fuel cell and the function f(Itrg, R, S) is obtained, and the voltage reduced amount can be evaluated based on the function f(Itrg, R, S). The threshold X is set in advance as a value that can suppress a reduction in the voltage and at which target output can be obtained.

If it is determined NO in step S2, the processing returns. On the other hand, if it is determined YES in step S2, the processing proceeds to step S3. In step S3, processing to reduce the current increase rate S is executed. More specifically, the target current value Itrg determined by the target current value determination section 21 is corrected by the target current value correction section 23 so as to be shifted to a reduced side. In order to correct the actual current value from the target current value Itrg and set to the reduced value, a boosting ratio in the fuel cell converter is changed. That is, the reduction in the current value is realized by changing a switching duty ratio (a time period ratio of ON/OFF) of a boosting circuit of the fuel cell converter 11. Noted that a reduced amount from the target current value Itrg can be determined based on a separation amount between the threshold X and a value of the function f(Itrg, R, S). That is, when the separation amount between the threshold X and the value of the function f(Itrg, R, S) is large, the reduced amount by correction is increased.

Just as described, the current value that is reduced from the target current value Itrg is set as a command value, and the current increase rate S is reduced. In this way, a flow amount of the oxidant gas supplied to the fuel cell stack 10 is reduced. As a result, dryness in the fuel cell stack 10 is suppressed, the deviation of the current distribution in the fuel cell stack 10 is suppressed, and furthermore, the reduction in the voltage is suppressed. Thus, output near the target output can promptly be obtained. When processing in step S3 is terminated, the processing returns.

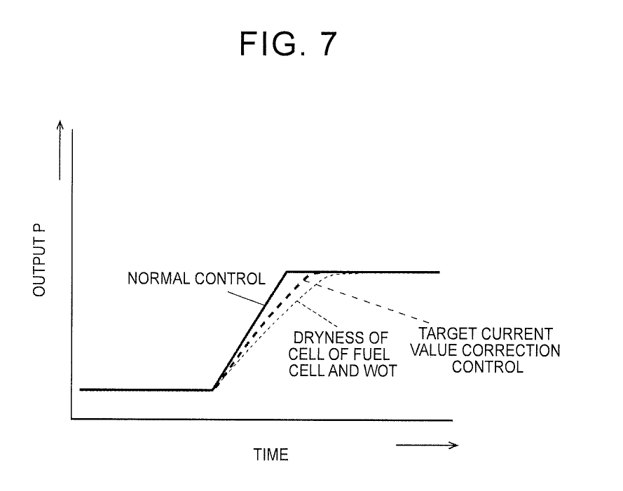

With reference to FIG. 7, when the target current value correction control is executed, dropping of the output P is alleviated in comparison with the case where the cell of the fuel cell is in the dried state and the rapid output increase request such as the WOT is made. Because the control of this embodiment is executed as described above, the output near the target output can promptly be obtained.

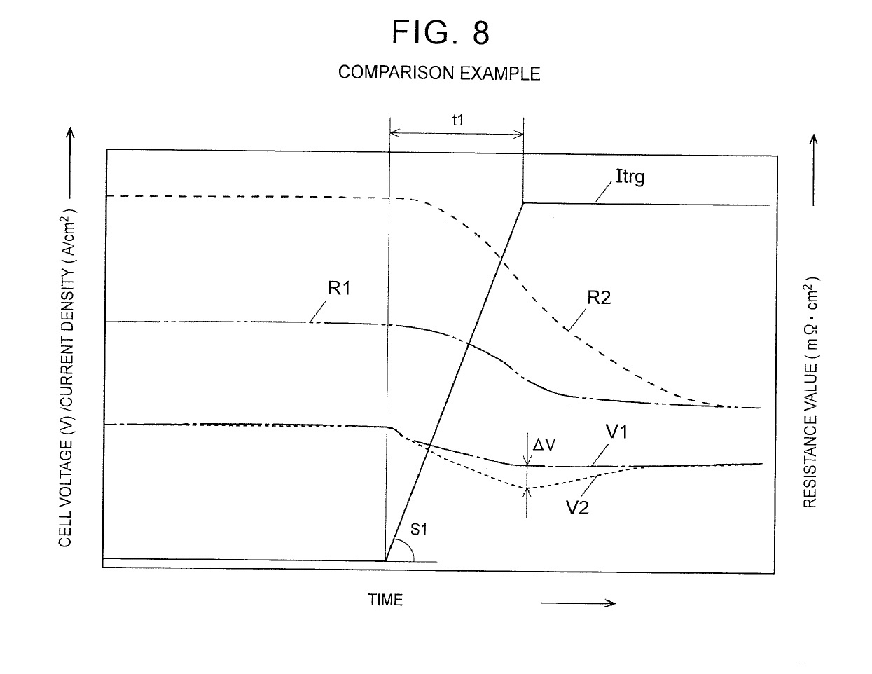

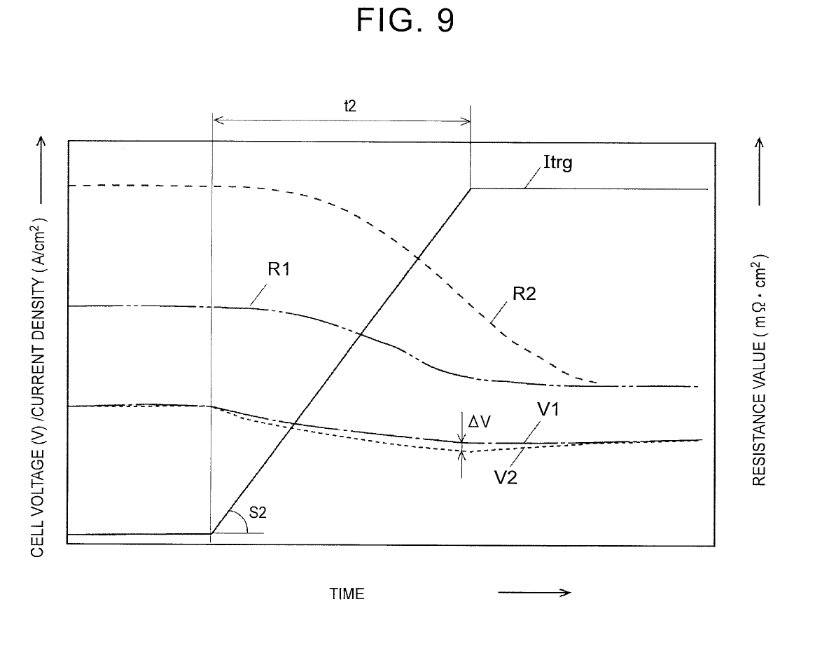

Here, a description will be made on effects achieved by suppression of the current increase rate S with reference to FIG. 8 and FIG. 9. FIG. 8 is a graph that shows a change in voltage V at a time when it takes a time period t1 for the current value to reach the target current value Itrg, more specifically, at a time when the current increase rate S is S1 by comparison between a case where the resistance value R is R1 and a case where the resistance value R is R2. Here, the resistance values R1, R2 are the resistance value of the fuel cell stack 10, and the resistance value R1<the resistance value R2. The voltage V at a time when the current increase rate S is S1 and the resistance value R is R1 is V1. Meanwhile, the voltage V at a time when the resistance value R is R2 is V2. The voltage V2 is significantly dropped when compared to the voltage V1.

Meanwhile, FIG. 9 is a graph that shows the change in the voltage V at a time when the current increase rate S is S2 and it takes a time period t2 for the current value to reach the target current value Itrg by comparison between the case where the resistance value R is R1 and the case where the resistance value R is R2. Here, t2>t1, and S1>S2. In addition, the resistance value R1<the resistance value R2. When the current increase rate S is S2, the voltage V at the time when the resistance value R is R1 is V1. Meanwhile, the voltage V at a time when the resistance value R is R2 is V2. The voltage V2 is slightly dropped when compared to the voltage V1, and thus is not significantly dropped as in FIG. 8.

As described above, in both of the cases, dropping of the voltage V is observed at the time when the resistance value R is large in comparison with the time when the resistance value R is small. However, an amount of dropping, that is, ΔV in each of the drawings is small in a result shown in FIG. 9, in which the current increase rate S is set to S2. Thus, dropping of the voltage V can be suppressed by reducing the current increase rate S. As a result, a reduction in the output can be suppressed.

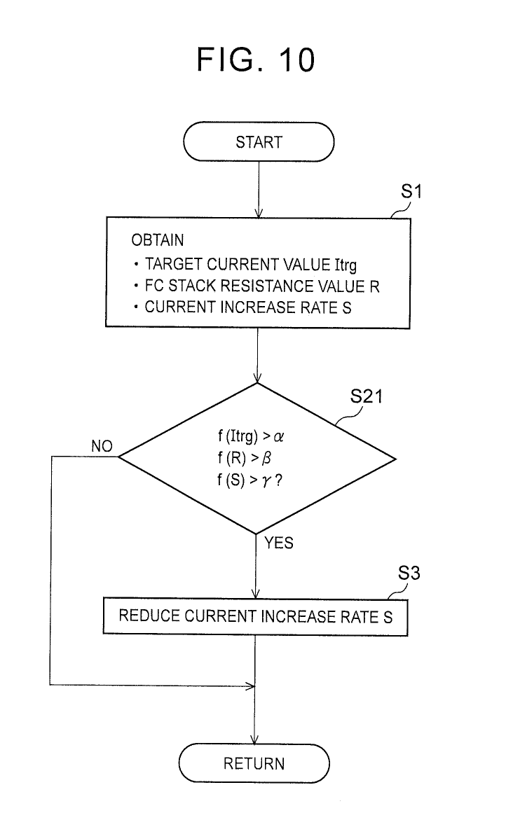

(Second Embodiment) Next, a description will be made on a second embodiment with reference to FIG. 10. FIG. 10 is a flowchart that shows one example of control of the fuel cell vehicle 100 of the second embodiment. Noted that, because the configuration of the fuel cell vehicle 100 itself does not differ from that in the first embodiment, the detailed description thereon will not be made.

In the second embodiment, step S21 is adopted instead of step S2 in the first embodiment. More specifically, in the second embodiment, it is determined whether functions f(Itrg), f(R), and f(S) on the target current value Itrg, the fuel cell stack resistance value R, and the current increase rate S are respectively larger than a threshold α [A/cm₂], a threshold β [mΩ·cm²], and a threshold γ [A/cm²/sec].

Here, similar to the threshold X in the first embodiment, each of the thresholds α, β, and γ is set in advance as a value at which the reduction in the voltage can be suppressed and the target output can be obtained. That is, the deviation of the current distribution in the cell of the fuel cell is correlated with the degree of dryness of the cell of the fuel cell, that is, the moisture distribution. In addition, the deviation of the current distribution causes the reduction in the voltage. As the deviation of the current distribution is increased, and as the current density on the oxygen outlet side is increased, the voltage reduced amount is also increased. Accordingly, in this embodiment, based on these findings, a relationship between the moisture distribution in the cell of the fuel cell and the voltage reduced amount is determined, and a relationship between the voltage reduced amount and each of the functions f(Itrg), f(R), and f(S) is determined in advance. In this way, a relationship between the moisture distribution in the cell of the fuel cell and each of the functions f(Itrg), f(R), and f(S) is obtained, and the voltage reduced amount can be evaluated based on the functions f(Itrg), f(R), and f(S).

Just as described, it may be determined whether the current increase rate S is reduced based on whether each of the functions on the separate parameters satisfies the specified condition. Because the operation in step S3 is similar to that in the first embodiment, the detailed description thereon will not be made.

Similar to the first embodiment, also in such a second embodiment, dryness of the fuel cell stack 10 is suppressed, and the deviation of the current distribution in the fuel cell stack 10 is suppressed. In addition, the reduction in the voltage is suppressed, and the output near the target output can promptly be obtained.

The above embodiments are merely examples for implementing the invention, and thus the invention is not limited thereto. Various modifications of these embodiments fall within the scope of the invention, and it is obvious from the above description that other various examples can further be implemented within the scope of the invention.

What is claimed is:

1. A fuel cell vehicle comprising:
a fuel cell stack that generates electric power when being supplied with oxidant gas and fuel gas;
an accelerating state detector that detects an accelerating state of the vehicle;
an electric resistance value detector that detects an electric resistance value of the fuel cell stack;
a current value detector that detects a current value of the fuel cell stack; and
a controller configured to
determine a target current value output from the fuel cell stack based on a requested output value of the fuel cell stack in accordance with the detected accelerating state,
determine a current increase rate based on a difference between the determined target current value and the detected current value, and
correct the determined target current value in such a manner as to reduce the determined target current value in a case where a value of a function that includes the determined target current value, the determined current increase rate, and the detected electric resistance value becomes larger than a predetermined threshold.

2. The fuel cell vehicle according to claim 1, wherein:
the value of the function is increased as the determined target current value is increased.

3. The fuel cell vehicle according to claim 1, wherein:
the value of the function is increased as the determined current increase rate is increased.

4. The fuel cell vehicle according to claim 1, wherein:
the value of the function is increased as the detected electric resistance value is increased.

5. The fuel cell vehicle according to claim 1, wherein:
a correction amount to reduce the determined target current value is increased as a difference between the value of the function and the threshold is increased.

6. A fuel cell vehicle comprising:
a fuel cell stack that generates electric power when being supplied with oxidant gas and fuel gas;
an accelerating state detector that detects an accelerating state of the vehicle;
an electric resistance value detector that detects an electric resistance value of the fuel cell stack;
a current value detector that detects a current value of the fuel cell stack; and
a controller configured to
determine a target current value output from the fuel cell stack based on a requested output value of the fuel cell stack in accordance with the detected accelerating state,
determine a current increase rate based on a difference between the target current value and the detected current value, and
correct the determined target current value in such a manner as to reduce the determined target current value in a case where at least one value among the determined target current value, the determined current increase rate, and the detected electric resistance value becomes larger than a threshold set for the at least one value.

7. The fuel cell vehicle according to claim 6, wherein:
a correct amount to reduce the determined target current value is increased as a difference between at least one of the determined target current value, the determined current increase rate, and the detected electric resistance value and the corresponding threshold is increased.
